(19) United States
(12) Patent Application Publication
(10) Pub. No.: US 2003/0200301 A1
(43) Pub. Date: Oct. 23, 2003

(54) Web-based network management system

(76) Inventors: Alan P. Trzcinko, Simi Valley, CA (US); Amparo Llanes, Thousand Oaks, CA (US); Gerhart Jerome JR., Moorpark, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/385,766

(22) Filed: Mar. 11, 2003

Related U.S. Application Data
(63) Continuation of application No. 09/438,066, filed on Nov. 10, 1999.

(51) Int. Cl. G06F 15/173

(52) U.S. Cl. 709/223

(57) ABSTRACT

The present invention provides a system and method for using a web browser to manage network devices. In accordance to one embodiment of the present invention, the system includes a web browser to submit Hyper Text Transfer Protocol (HTTP) requests for a mark-up language file that contains one or more embedded SNMP object identifiers. The system further includes a network device which has an embedded web server to process the HTTP requests.

### FIELD OF THE INVENTION

This invention relates generally to the field of device configuration, network management, and particularly to Web-based network management systems.

### BACKGROUND OF THE INVENTION

A number of factors are driving the demand for adding Web-based configuration and management capabilities to network devices. These factors include: (i) the emergence of the graphical, user-friendly, platform-independent, and free web browser as the lowest common denominator point of network access, (ii) the ongoing industry movement to open standards with TCP/IP being embraced as the de facto standard for network devices, and (iii) the shift of growth in adoption of networking technologies from predominantly homogeneous, technical information technology (IT) enterprises to heterogeneous, non-technical users. From this backdrop, the web browser has emerged as a tool of choice for configuration, management, monitoring, control, and support of network devices. The web browser provides a graphical user interface (GUI) that is more user-friendly than the traditional command line configuration interfaces. Consequently, Web-based management has become a desirable feature in network devices.

### SUMMARY OF THE INVENTION

The present invention provides a system and method for using a web browser to manage network devices. In accordance to one embodiment of the present invention, the system includes a network management station which has a web browser to submit Hyper Text Transfer Protocol (HTTP) requests for a mark-up language file that contains one or more embedded object identifiers. The system further includes a network device which has an embedded web server to process the HTTP requests.

A mark-up language file represents or describes network management web pages using a mark-up language, such as Hyper Text Mark-Up Language (HTML), Extensible Mark-Up Language (XML), or the like. An object identifier (OID) is generally a sequence of positive integers reflecting a hierarchical or tree structure of objects in a Management Information Base (MIB). Given the tree structure of a MIB, the object identifier for a particular object may be derived by tracing a path from the root of the tree structure to the particular object. By embedding object identifiers in the mark-up language files or pages, the embedded web server no longer has- to translate or map data fields in the markup language files or pages to objects in a MIB. Rather, the embedded web server can now extract the object identifiers from the mark-up language files or pages and pass these object identifiers to a Simple Network Management Protocol (SNMP) agent residing on a network device. Therefore, the embedded web server does not need to look up the MIB variables to get the object identifiers. As a result, updated mark-up language files or pages could be delivered independently and quickly to the market place without having to wait for updates to the executable image of the embedded web server. Furthermore, mark-up language files or pages can be independently customized to meet the specific needs of customers without having to update the embedded web server. Accordingly, customers may receive or develop unique mark-up language files or pages based on their requirements without changing the embedded web server software.

The above described and many other features of the present invention will become apparent as the invention becomes better understood by reference to the following detailed description when considered in conjunction with the accompanying drawings.

### BRIEF DESCRIPTION OF THE DRAWINGS

FIG. 1 illustrates a diagram of a network system in accordance with one embodiment of the present invention.

FIGS. 2 and 3 show a simplified version of the network system illustrated in FIG. 1.

FIG. 4 illustrates an exemplary object identifier tree structure.

FIG. 5 illustrates an exemplary network management web page as displayed on a graphics monitor by the browser residing on the network management workstation.

FIG. 6 is a partial hardcopy that includes pertinent portions of an exemplary HTML file corresponding to the network management web page illustrated in FIG. 5.

FIG. 7 illustrates an exemplary sequence of events occurring when the network manager uses the web browser on the network management station to submit an HTTP GET request to the network device.

FIG. 8 illustrates an exemplary sequence of events occurring when the network manager uses the web browser on the network management station to make HTTP POST requests.

### DETAILED DISCLOSURE OF THE EMBODIMENTS

The present invention provides a system and method for using a web browser to manage network devices.

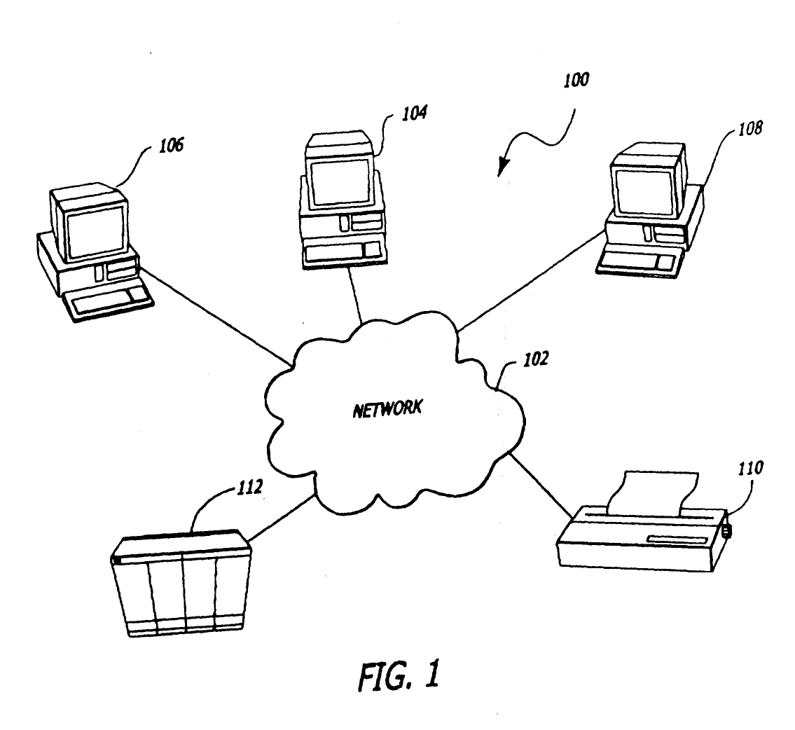

FIG. 1 is a diagram of a network system 100 in accordance with one embodiment of the present invention. The system 100 includes a network 102 coupling together a network management station 104 and a plurality of network devices 106, 108, 110, and 112. Network management station 104 is generally a computing device which is used to manage and monitor devices in the network. Being a computing device, network management station 104 includes a processing unit to process data. A processing unit may generally be a central processing unit (CPUs), a micro-controller, a field programmable logic array (FPLA), a field programmable gate array (FPGA), or any combinational logic circuitry capable of processing data. Examples of a network management station 104 may include a desktop computer, a notebook, a mid-range workstation, a handheld device, or the like. Network devices 106, 108, 110, and 112 are generally computing devices having networking capability. As illustrated in FIG. 1, examples of network devices may include a desktop computer 106, a mid-range workstation 108, a network printer 110, and a switching/routing device 112. In practice, a network device may be a set-top-box, a server, a handheld device, or any computing devices with networking capability.

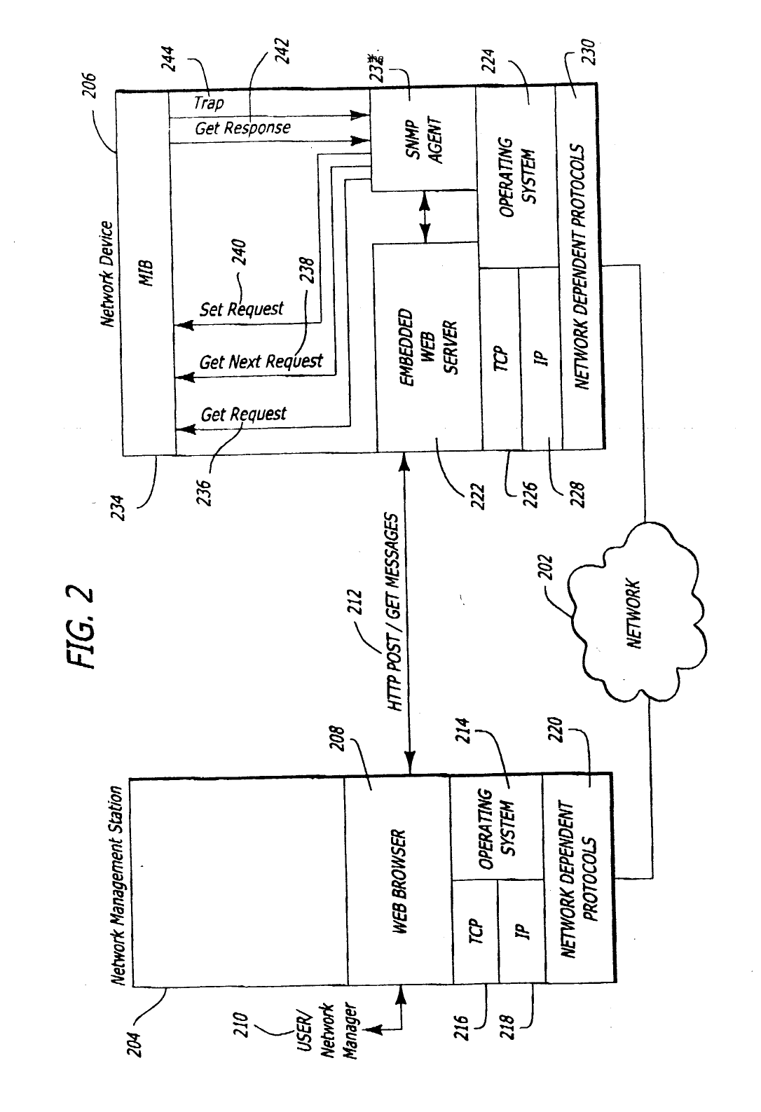

FIGS. 2 and 3 show a simplified version of the network system shown in FIG. 1, including a network 202 coupling together network management station 204 and network device 206. In this embodiment, network management station 204 is a shared device that is IP-based. As stated above, examples of a network management station 204 may include a desktop computer, a notebook, a mid-range workstation, a handheld device, or the like. In this embodiment, network device 206 is an IP-based computing device which includes a processing unit. Examples of network devices may include a desktop computer, a midrange workstation, a switching/routing device, a network printer, a set-top-box, a server, a handheld device, or the like.

As shown in FIGS. 2 and 3, network management station 204 includes a standard web browser 208, (e.g., Netscape Navigator™ by America Online, Inc. of Dulles, Va. or Internet Explorer™ by Microsoft® Corporation of Redmond, Wash.) to interface with a network manager 210 to receive work requests from network manager 210. Furthermore, web browser 208 is also used to communicate results of work requests to network manager 210. Network management station 204 carries out work requests from the network manager by submitting Hyper Text Transfer Protocol (HTTP) POST and GET requests 212 to network device 206. Network management station 206 submits these HTTP POST and GET requests 212 through web browser 208, which is implemented on top of operating system 214, TCP/IP 216, and 218, and network-dependent protocols 220 (for example, Ethernet, FDDI, X.25, or the like).

Network device 206 includes an embedded web server 222 to communicate with web browser 208 on network management station 204. Embedded web server 222 is implemented on top of operating system 224, TCP/IP 226, and 228, and network-dependent protocols 230 (for example Ethernet, FDDI, X.25, or the like). In one embodiment, operating system 224 employed in network device 206 is a real time operating system (RTOS). An example of an off-the-shelf RTOS is VxWorks® developed by Wind River Systems, Inc. of Alameda, Calif. Operating system 224 generally provides low-level services such as memory allocation, semaphores, network services, etc.

Network device 206 further includes a Simple Network Management Protocol (SNMP) agent 232 to support the SNMP protocol, which is a widely used network monitor and control protocol. SNMP agent 232 is a hardware or software module that generally responds to requests for information and actions from network management station 204. In an SNMP management model, resources or devices in a network are represented by objects. An object is generally a data variable that represents a unique aspect of network devices in the network. A Management Information Base (MIB) 234 is a collection of objects. SNMP agent 232 utilizes objects contained in the MIB 234 to determine what information is available from the network device 206 and to determine which aspects of the network device 206 can be controlled. Examples of standard MIBs include MIB-I as defined in Requests for Comments (RFC) 1156 and MIB-II as defined in Requests for Comments (RFC) 1213. It should also be noted that network device vendors may also define proprietary MIBs to cover unique aspects of their network devices.

SNMP defines various types of messages for retrieving and updating values of MIB objects, including GetRequest 236, GetNextRequest 238, SetRequest 240, GetResponse 242, and Trap 244. GetRequest 236 and GetNextRequest 238 are generally used to retrieve values of MIB objects stored on network device 206. SetRequest 240 is typically used to set values of those MIB objects. GetResponse 242 is generally used to acknowledge the reception of GetRequest 236, GetNextRequest 238, and SetRequest 240 messages. Trap 244 is used to alert network management station to events or exceptions that affect MIB objects.

In addition, SNMP uses an identification scheme defined by Abstract Syntax Notation One (ASN.1) to uniquely identify objects in a MIB. In this scheme, an identifier is called an object identifier (OID). The permanent assignment of an OID to a MIB object is called registration. Once a registration has been completed, no other MIB object may be registered with the same OID. Furthermore, the registered object may not be deleted, and the characteristics of the registered object may not be changed.

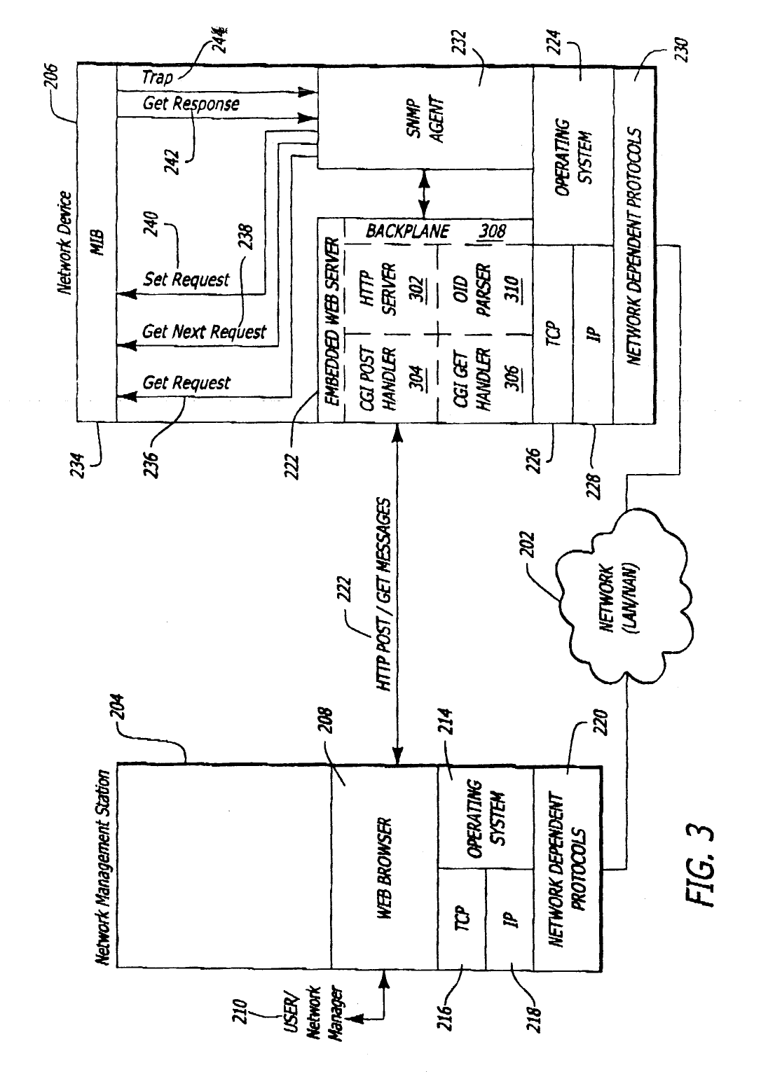

An OID is generally a sequence of positive integers that reflects a hierarchical or tree structure of objects in a MIB. Given the tree structure of a MIB, the object identifier for a particular object may be derived by tracing a path from the root of the tree structure to the particular object. FIG. 4 illustrates an exemplary tree structure 400 including ipRouteTable 402, which is a MIB object that which is included MIB-II as defined by Requests for Comments (RFC) 1213. In RFC 1213, ipRouteTable 402 is assigned an OID of “1.3.6.1.2.1.4.21”. Since ipRouteEntry 404 corresponds to the first branch 406 of the ipRouteTable tree structure 400, ipRouteEntry 404 is accordingly assigned an OID of “1.3.6.1.2.1.4.21.1”. Furthermore, ipRouteDest 408, ipRouteMetric 410, and ipRouteNextHop 412 correspond respectively to the first branch 414, third branch 416, and seventh branch 418 of the ipRouteEntry tree branch 406. Accordingly, ipRouteDest 408, ipRouteMetric 410, and ipRouteNextHop 412 are assigned OIDs of “1.3.6.1.2.1.4.21.1.1”, “1.3.6.1.2.1.4.21.1.3”,and “1.3.6.1.2.1.4.21.1.7” respectively.

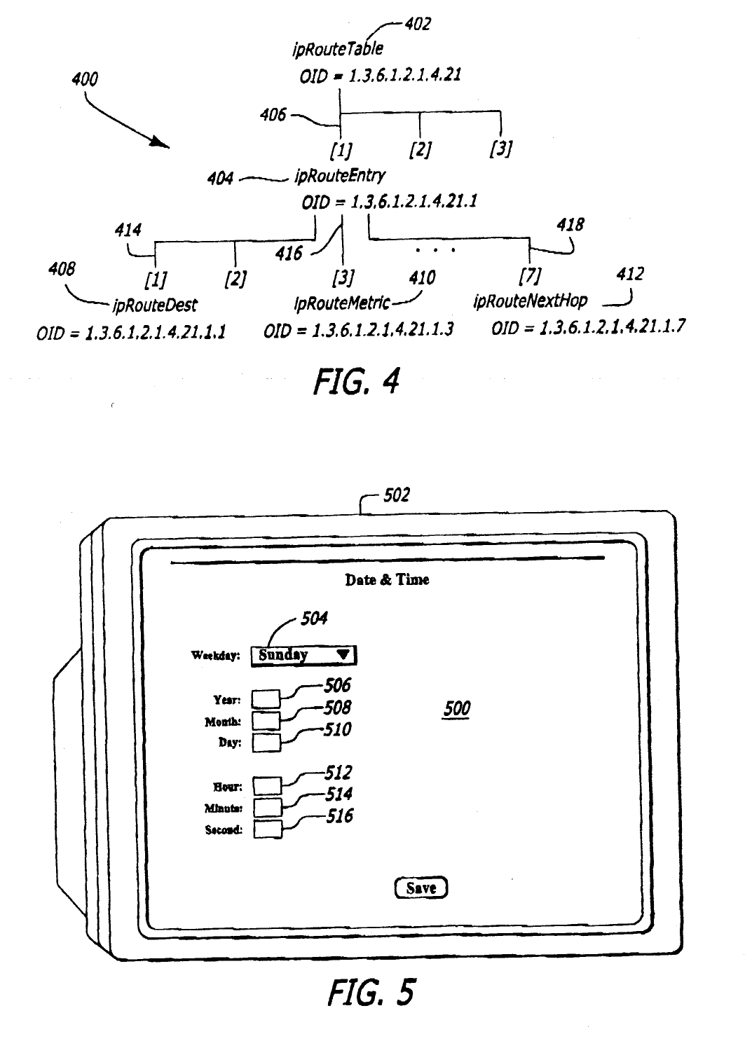

Turning now to FIG. 5, an illustrative embodiment of a network management web page 500, as displayed on a graphics monitor 502 by the browser residing on the network management workstation, is shown. As illustrated, network management web page 500 includes numerous data fields 504-516, where a network manager may enter or display data. Network management web page 500 is typically represented or described using a mark-up language. Examples of mark-up languages include Hyper Text Mark-Up Language (HTML), Extensible Mark-Up Language (XML), or the like.

In the embodiment illustrated in FIG. 5, network management web page 500 includes text box fields Year 506, Month 508, Day 510, Hour 512, Minute 514, and Second 516, and select box Weekday 504. It should be noted that web page 500, as shown in FIG. 5, is used merely for illustrative purposes. In reality, network management web pages in accordance with the present invention may specify other types of data fields, such as checkboxes, radio buttons, multiple-select boxes, etc.

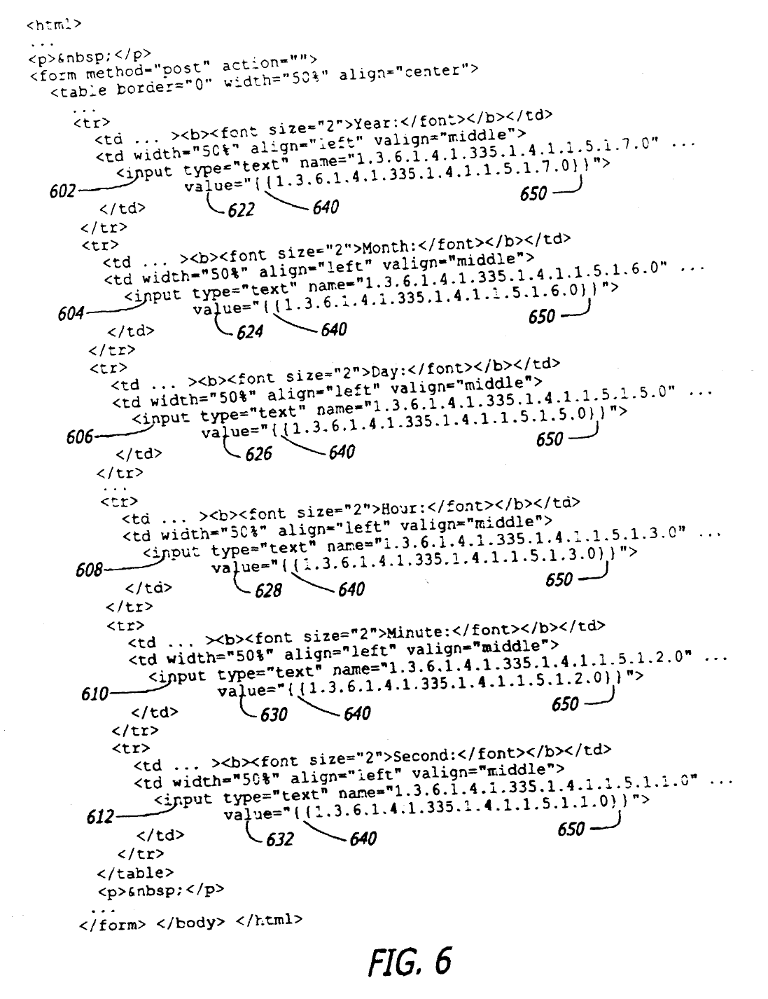

FIG. 6 is a partial hardcopy that includes pertinent portions of an exemplary HTML file corresponding to the network management web page 500 illustrated in FIG. 5. The exemplary HTML file contains input tags 602, 604, 606, 608, 610, and 612, corresponding to the Year 506, Month 508, Day 510, Hour 512, Minute 514, and Second 516 text box fields respectively, as shown in FIG. 5. Value fields 622, 624, 626, 628, 630, and 632 in input tags 602, 604, 606, 608, 610, and 612 contain the object identifiers of MIB objects representing the text box fields Year, Month, Day, Hour, Minute, and Second. For example, value field 622 contains an OID of “1.3.6.1.4.1.335.1.4.1.1.5.1.7.0” assigned to a MIB object representing the Year text box field. As another example, value field 624 contains an OID of “1.3.6.1.4.1.335.1.4.1.1.5.1.6.0” assigned to a MIB object representing the Month text box field.

As stated above, network management web page 500 can be represented or described using a variety of mark-up languages. FIG. 6 merely illustrates an example where HTML is used to represent or describe network management web page 500, as shown in FIG. 5. In practice, network management web page 500 can be represented or described using other mark-up languages, such as XML or the like.

Each OID is preceded by an implementation specific OID begin marker 640 and followed by an OID end marker 650. It should be noted that standard HTML does not provide for OID begin 640 and end 650 markers. Therefore, these markers 640 and 650 are enhancements or extensions to standard HTML. In this embodiment, the string “{{” 640 is used to denote the OID begin marker, and the string “}}” 650 is used to denote the OID end marker. In practice, any alphanumeric strings that are not used by standard HTML may be used to denote OID end and begin markers 640 and 650.

Returning to FIG. 3, embedded web server 222 includes a standard HTTP server 302 that is compliant to RFC 1945. Embedded web server 222 also includes a set of Common Gateway Interface (CGI) handlers, including CGI POST handler 304 and CGI GET handler 306. It should be noted that CGI is a standard approach to handle data exchanges between an HTTP server 302 and ancillary programs or processes running on network device 206. In this embodiment, an example of an ancillary program may be the SNMP agent 232. Embedded web server 222 further includes a backplane 308, which generally provides a unique access or entry point to SNMP agent 232. In addition, embedded web server 222 includes an OID parser 310 to substitute and/or extract object identifiers.

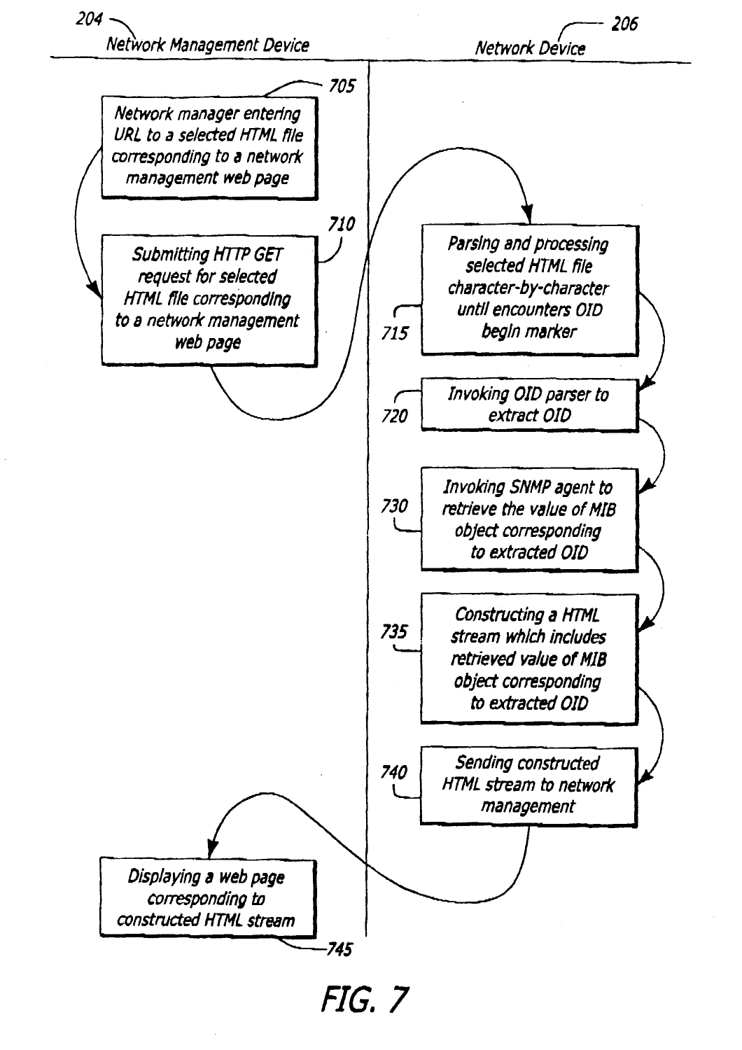

FIG. 7 illustrates an exemplary sequence of events occurring when the network manager uses the web browser on the network management station to submit an HTTP GET request to the network device. It should be noted that in FIG. 7 and the following text describing FIG. 7, HTML is used merely for illustrative purposes. As stated above, other mark-up languages, such as XML or the like, can be used in place of HTML to practice the current invention.

In block 705 of FIG. 7, the network manager enters the Uniform Resource Locator (URL) corresponding to a selected HTML file that represents a network management web page containing data fields that the network manager wishes to view or to manipulate. Then the web browser on the network management station 204 is used to submit an HTTP GET request for the selected HTML file (block 710).

An exemplary HTML file is illustrated in FIG. 6 and described above. The selected HTML file typically includes HTML tags defining data fields, object identifiers assigned to MIB objects representing the data fields, and pairs of OID begin and end markers encapsulating each OID.

Upon receiving the URL, network device loads the selected HTML file corresponding to the URL into the CGI GET handler of the embedded web server on the network device. The CGI GET handler parses and processes the selected HTML file character-by-character until the handler encounters an OID begin marker (block 715).

As shown in FIG. 5 and described above, an exemplary OID begin marker is denoted by the string “{{” In particular, the text box field Year is defined as followed:

<td width=“50%” align=“left” valign=“middle”>

<input type=“text”
name=“1.3.6.1.4.1.335.1.4.1.1.5.1.7.0”
value=“{{1.3.6.1.4.1.335.1.4.1.1.5.1.7.0}}”>

</td>

As illustrated, the value field contains an OID of “1.3.6.1.4.1.335.1.4.1.1.5.1.7.0”, which is encapsulated by OID begin marker “{{” and OID end marker “}}”.

The OID begin marker, which does not appear in any ordinary HTML, signifies to CGI GET handler that the following text is an OID. At this stage, CGI GET handler invokes the OID parser to parse out or extract the OID (block 720). Then, CGI GET handler invokes the SNMP agent to retrieve the data associated with the MIB object corresponding to the extracted OID, constructs an HTML stream, and copies the retrieved data associated with the MIB object into the HTML stream (block 735).

Continuing with the aforementioned example with the Year text box field, let's assume that CGI GET handler invokes the SNMP agent and retrieves “1999” as data associated with the text box field Year. CGI GET handler then constructs the following partial HTML stream:

<td width=“50%” align=“left” valign=“middle”>

>input type=“text”
name=“1.3.6.1.4.1.335.1.4.1.1.5.1.7.0” . . .
value=“1999”>

</td>

In the above HTML stream, “1999” replaces the string “{{1.3.6.1.4.1.335.1.4.1.1.5.1.7.0}} ”, which represents the exemplary OID begin marker, OID, and OID end marker.

Once the HTML stream is constructed, the network device uses the embedded web server to send the constructed HTML stream to the web browser on the network management station (block 740). The network management station then uses the web browser to display the constructed HTML stream on a graphics monitor (block 745).

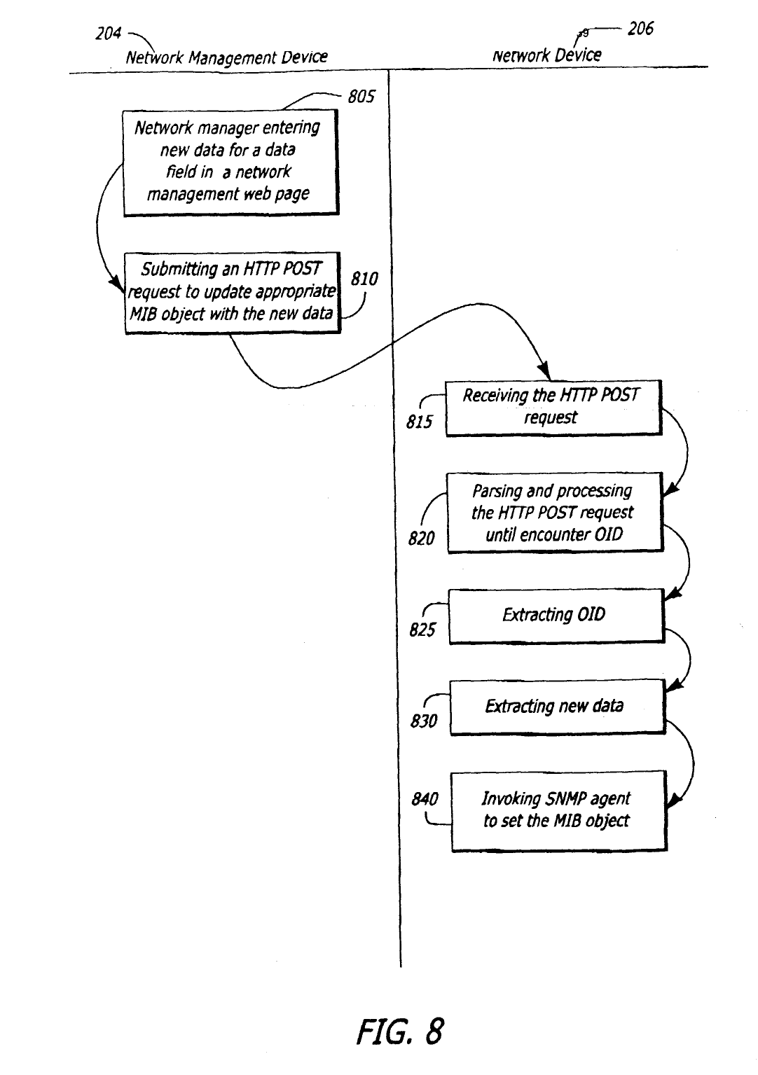

FIG. 8 illustrates an exemplary sequence of events occurring when the network manager uses the web browser on the network management station to make HTTP POST requests. It should be noted that in FIG. 8 and the following text describing FIG. 8, HTML is used merely for illustrative purposes. As stated above, other mark-up languages, such as XML or the like, can be used in place of HTML to practice the current invention.

In general, HTTP POST requests are used to update objects in the MIB which is stored on the network device 206. When a network manager wishes to change the data associated with a data field in a network management web page, he or she simply enters the new data associated with the data field and instructs the web browser on the network management station to submit the new data to the network device (block 805).

At this stage, the web browser submits an HTTP POST request to the embedded web server on the network device (block 810). The HTTP POST request includes a CGI stream depicting the new data that the network manager entered. The CGI stream includes the new data and the OID corresponding to the MIB object to which the new data is to be applied.

Continuing with the aforementioned example with the Year text box field, presume that the network manager wishes to enter “2000” in lieu of “1999” in the Year text box field and instructs the web browser on the network management station to submit this new data, “2000”, to the network device. The web browser constructs a HTTP POST request and sends the message to the network device. The HTTP POST request may include the following CGI stream:

&1.3.6.1.4.1.335.1.4.1.1.5.1.7.0=2000&

The string “1.3.6.1.4.1.335.1.4.1.1.5.1.7.0” represents the OID assigned to a MIB object corresponding to the Year text box field. The string “2000” represents the new data that the network manager entered in the Year text box field.

In block 815, the network device receives the HTTP POST request which contains the CGI stream and passes the message to the CGI POST handler. From there, the CGI POST handler parses and processes the CGI stream until an OID is encountered (block 820). At this stage, the CGI POST handler invokes the OID parser to extract the OID (block 825). The new data accompanying the OID is then extracted (block 830). Afterward, the CGI POST handler invokes the SNMP agent to set the MIB object, corresponding to the extracted OID, to the extracted new data (block 840).

It should be noted that the functional components illustrated in FIGS. 2 and 3 and discussed above may be implemented in hardware or software. If the aforementioned functional components are implemented in software, these components can be stored on a computer-readable medium, such as floppy disk, hard drive, CD-ROM, DVD, tape, memory, or any storage device that is accessible by a computer.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A system to manage devices in a network, comprising:
a network management station including a web browser to submit Hyper Text Transfer Protocol (HTTP) requests for a mark-up language file having at least one embedded object identifier (OID); and
a network device in communication with the network management station, the network device including an embedded web server to process the HTTP requests.

2. The system of claim 1, wherein the HTTP requests include HTTP POST requests to update values of objects in a Management Information Base (MIB) stored on the network device.

3. The system of claim 1, wherein the HTTP requests include HTTP GET requests to retrieve values of objects in a Management Information Base (MIB) stored on the network device.

4. The system of claim 1, wherein the mark-up language file includes at least one data field where a network manager enters data.

5. The system of claim 4, wherein each of the at least one embedded object identifier (OID) is assigned to a Management Information Base (MIB) object corresponding to one of the at least one data field.

6. The system of claim 1, wherein the embedded web server communicates with the web browser to receive and process the HTTP requests submitted by the web browser.

7. The system of claim 1, wherein the network device further includes a Simple Network Management Protocol (SNMP) agent to access and update objects in a Management Information Base (MIB) stored on the network device.

8. The system of claim 7, wherein the embedded web server extracts the at least one embedded object identifier (OID) in the mark-up language file and passes the at least one embedded OID to the SNMP agent.

9. The system of claim 8, wherein the embedded web server includes an OID parser to extract the at least one OID in the mark-up language file.

10. The system of claim 1, wherein the embedded web server includes an HTTP server that is compliant to Requests for Comments (RFC) 1945.

11. The system of claim 1, wherein the embedded web server includes Common Gateway Interface (CGI) handlers to process HTTP POST and GET requests.

12. A network management station, comprising:
a processing unit executing a web browser to submit Hyper Text Transfer Protocol (HTTP) requests for a mark-up language file having at least one embedded object identifier (OID).

13. The network management station of claim 12, wherein the mark-up language file includes at least one data field.

14. The network management station of claim 13, wherein each of the at least one object identifier (OID) is assigned to a Management Information Base (MIB) object corresponding to each of the at least one data field.

15. The network management station of claim 14, wherein the HTTP requests include HTTP GET requests to retrieve values of the MIB object.

16. The network management station of claim 14, wherein the HTTP requests include HTTP POST requests to update values of the MIB object.

17. A network device, comprising:
a Simple Network Management Protocol (SNMP) agent to access and update objects in a Management Information Base (MIB) stored on the network device; and
an embedded web server to process a mark-up language file having at least one embedded object identifier (OID), the embedded web server extracts the at least one object identifier (OID) from the HTML file and passes the at least one embedded OID to the SNMP agent.

18. The network device of claim 17, wherein each of the at least one object identifier (OID) is preceded by an OID begin marker and is followed by an OID end marker.

19. The network device of claim 17, wherein:
the mark-up language file includes at least one data field where a network manager enters data; and
each of the at least one object identifiers is assigned to a Management Information Base (MIB) object corresponding to each of the at least one data field.

20. The network device of claim 17, wherein the embedded web server includes an OID parser to extract the at least one embedded OID in the mark-up language file.

21. The network device of claim 17, wherein the embedded web server includes an HTTP server that is compliant to Requests for Comments (RFC) 1945.

22. The network device of claim 17, wherein the embedded web server includes Common Gateway Interface (CGI) handlers to process HTTP POST and GET requests.

23. A method to manage network devices, comprising:
embedding object identifiers in a mark-up language file containing data fields, the embedded object identifiers corresponding to data fields in the markup language file;
submitting Hyper Text Transfer Protocol (HTTP) requests for the mark-up language file;
extracting the embedded object identifiers from the mark-up language file; and
forwarding the extracted embedded object identifiers to an SNMP agent.

24. A computer program embodied on a computer-readable medium, comprising:
an embedded web server to process a mark-up language file having at least one embedded object identifier (OID) corresponding to at least one data field in the mark-up language file.

25. The computer program of claim 24, further comprising:
a Simple Network Management Protocol (SNMP) agent to access and update objects in a Management Information Base (MIB), wherein the embedded web server extracts the at least one embedded object identifier (OID) from the mark-up language file and passes the at least one embedded object identifier to the SNMP agent.

26. The computer program of claim 24, wherein the mark-up language file is constructed using a Hyper Text Mark-Up Language (HTML).

27. The computer program of claim 24, wherein the mark-up language file is constructed using an Extensible Mark-Up Language (XML).
